(19) United States
(12) Patent Application Publication
(10) Pub. No.: US 2019/0253921 A1
(43) Pub. Date: Aug. 15, 2019

(54) METHOD FOR TRANSMITTING AND RECEIVING DATA IN WIRELESS COMMUNICATION SYSTEM AND APPARATUS FOR THE SAME

(71) Applicant: Electronics and Telecommunications Research Institute, Daejeon (KR)

(72) Inventor: Jae Wook SHIN, Sejong-si (KR)

(21) Appl. No.: 16/269,945

(22) Filed: Feb. 7, 2019

(30) Foreign Application Priority Data
Feb. 13, 2018 (KR) 10-2018-0018043

(51) Int. Cl. H04W 28/04; H04W 28/06; H04L 1/18

(52) U.S. Cl. CPC H04W 28/04; H04L 1/188; H04W 28/06

(57) ABSTRACT

A method for transmitting data, performed by a transmitting apparatus in a wireless communication system, includes: transmitting a last acknowledged mode data (AMD) packet data unit (PDU) segment to a receiving apparatus, and activating a retransmission timer; identifying whether status report transmitted by the receiving apparatus is received until expiration of the retransmission timer; and when the status report is not received until the expiration of the retransmission timer, and a new AMD PDU and a retransmission-pending AMD PDU are not present in a data buffer, retransmitting the last AMD PDU segment to the receiving apparatus.

### CROSS-REFERENCE TO RELATED APPLICATION

This application claims priority to Korean Patent Application No. 10-2018-0018043, filed on Feb. 13, 2018 in the Korean Intellectual Property Office (KIPO), the entire content of which is hereby incorporated by reference.

### BACKGROUND

### 1. Technical Field

The present disclosure relates to a method and an apparatus for transmitting and receiving data in a wireless communication system, and more particularly, to a method and an apparatus for transmitting and receiving retransmission data for reducing an unnecessary overhead.

### 2. Description of Related Art

The transmission reliability on an air interface between both ends of a transmitting apparatus and a receiving apparatus in a wireless communication system is secured by a hybrid automatic repeat request (HARQ) technique in a physical layer and a medium access control (MAC) layer and an automatic repeat request (ARQ) technique in a radio link control (RLC) layer.

The data (e.g., packet or data packet) generated in an application layer is segmented or concatenated according to the size of radio resources available in the RLC layer of the transmitting apparatus on the air interface, configured as an RLC acknowledged mode data (AMD) packet data unit (PDU), and transmitted to the RLC layer of the receiving apparatus. When configuring the AMD PDU, if there is no data to be transmitted in a data buffer (including a transmission buffer in which a new AMD PDU is stored and a retransmission buffer in which an AMD PDU to be retransmitted is stored), the RLC layer of the transmitting apparatus sets a poll bit in a control field region of the AMD PDU. When the receiving apparatus receives the AMD PDU with the poll bit set, the receiving apparatus may transmit a STATUS PDU to the transmitting apparatus to inform status information on AMD PDUs having been received so far.

However, when generation of data (i.e., AMD PDU) to be transmitted by the transmitting apparatus is intermittent, if the last transmitted AMD PDU is lost in a radio channel, it may be difficult for the receiving apparatus to detect it, and an unnecessary retransmission-related overhead may occur even when it is detected.

### SUMMARY

In order to solve the above-described problem, embodiments of the present disclosure provide a data transmission and reception method of a transceiving apparatus for preventing unnecessary redundant data transmissions and reducing transmission latency in a wireless communication system.

In order to solve the above-described problem, embodiments of the present disclosure also provide a transmitting apparatus for efficiently using radio resources by preventing unnecessary redundant data transmissions in a wireless communication system.

In order to achieve the objective of the present disclosure, a method for transmitting data, performed by a transmitting apparatus in a wireless communication system, may comprise transmitting a last acknowledged mode data (AMD) packet data unit (PDU) segment to a receiving apparatus, and activating a retransmission timer; identifying whether status report transmitted by the receiving apparatus is received until expiration of the retransmission timer; and when the status report is not received until the expiration of the retransmission timer, and a new AMD PDU and a retransmission-pending AMD PDU are not present in a data buffer, retransmitting the last AMD PDU segment to the receiving apparatus.

The method may further comprise, when the status report is received until the expiration of the retransmission timer, and at least one of a new AMD PDU and a retransmission-pending AMD PDU is present in the data buffer, not transmitting the last AMD PDU to the receiving apparatus.

The status report may include at least one of information indicating whether at least one AMD PDU segment has been normally received by the receiving apparatus and information on a sequence number of the at least one AMD PDU segment.

The status report may further include a sequence number of an AMD PDU that the receiving apparatus is waiting to receive.

The last AMD PDU segment may include a poll bit indicating that the last AMD PDU segment is a last segment among a plurality of AMD PDU segments.

The data buffer may include at least one of a transmission buffer in which a new AMD PDU is stored and a retransmission buffer in which an AMD PDU required to be retransmitted is stored.

In order to achieve the objective of the present disclosure, a method for receiving data, performed by a receiving apparatus in a wireless communication system, may comprise receiving at least one acknowledged mode data (AMD) packet data unit (PDU) segment for which a poll bit is not set from a transmitting apparatus, and activating a reception timer; terminating the reception timer when at least one of AMD PDU segments for which the poll bit is set is received until expiration of the reception timer; and transmitting status report to the transmitting apparatus when the reception timer expires.

The method may further comprise receiving at least one AMD PDU segment from the transmitting apparatus, wherein the transmitting apparatus receives the status report until expiration of a retransmission timer, initializes the retransmission timer, and retransmit the at least one AMD PDU segment based on a status of a data buffer of the transmitting apparatus and the status report.

The status report may include at least one of information indicating whether at least one AMD PDU segment has been normally received by the receiving apparatus and information on a sequence number of the at least one AMD PDU segment.

The status report may further include a sequence number of an AMD PDU that the receiving apparatus is waiting to receive.

The data buffer may include at least one of a transmission buffer in which a new AMD PDU is stored and a retransmission buffer in which an AMD PDU required to be retransmitted is stored.

The AMD PDU segment retransmitted by the transmitting apparatus may be an AMD PDU segment for which the poll bit is set.

In order to achieve the objective of the present disclosure, a transmitting apparatus in a wireless communication system may comprise at least one processor, a memory storing at least one instruction executed by the at least one processor, and a transceiver controlled by the at least one processor, wherein the at least one instruction is configured to transmit, by using the transceiver, a last acknowledged mode data (AMD) packet data unit (PDU) segment to a receiving apparatus, and activating a retransmission timer; identify whether status report transmitted by the receiving apparatus is received until expiration of the retransmission timer; and when the status report is not received until the expiration of the retransmission timer, and a new AMD PDU and a retransmission-pending AMD PDU are not present in a data buffer, retransmit the last AMD PDU segment to the receiving apparatus.

When the status report is received until the expiration of the retransmission timer, and at least one of a new AMD PDU and an AMD PDU of a retransmission-pending AMD PDU is present in the data buffer, the at least one instruction may be further configured not to transmit the last AMD PDU to the receiving apparatus.

The status report may include at least one of information indicating whether at least one AMD PDU segment has been normally received by the receiving apparatus and information on a sequence number of the at least one AMD PDU segment.

The status report may further include a sequence number of an AMD PDU that the receiving apparatus is waiting to receive.

The last AMD PDU segment may include a poll bit indicating that the last AMD PDU segment is a last segment among a plurality of AMD PDU segments.

The data buffer may include at least one of a transmission buffer in which a new AMD PDU is stored and a retransmission buffer in which an AMD PDU required to be retransmitted is stored.

According to the embodiment of the present disclosure, when an AMD PDU is retransmitted in the RLC layer, unnecessary redundant transmission is prevented, so that limited radio resources can be efficiently used, and data transmission latency can be reduced.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first embodiment of a communication system;

FIG. 2 is a block diagram illustrating a first embodiment of a communication node constituting a communication system;

FIG. 3 is a conceptual diagram for explaining a conventional method of generating an RLC PDU in an RLC layer;

FIG. 4 is a conceptual diagram for explaining a conventional method of retransmitting data in an RLC layer;

FIG. 5 is a conceptual diagram for explaining a conventional method for segmenting an RLC PDU;

FIG. 6 is a sequence chart illustrating a conventional method of transmitting an AMD PDU;

FIG. 7 is a sequence chart for explaining a conventional method of retransmitting an AMD PDU using a status report;

FIG. 8 is a sequence chart for explaining a conventional method of retransmitting an AMD PDU using a retransmission timer;

FIG. 9 is a sequence chart for explaining a conventional method of retransmitting an AMD PDU segment;

FIG. 10 is a sequence chart for explaining another conventional method of retransmitting an AMD PDU segment;

FIG. 11 is a sequence chart for explaining a method of retransmitting an AMD PDU segment according to an embodiment of the present disclosure;

FIG. 12 is a sequence chart for explaining a method of retransmitting an AMD PDU segment according to another embodiment of the present disclosure;

FIG. 13 is a sequence chart for explaining a method of retransmitting an AMD PDU segment using a reception timer according to an embodiment of the present disclosure; and

FIG. 14 is a sequence chart for explaining a method for retransmitting an AMD PDU using a reception timer according to an embodiment of the present disclosure.

### DETAILED DESCRIPTION OF THE INVENTION

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present invention. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present invention pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, exemplary embodiments of the present invention will be described in greater detail with reference to the accompanying drawings. To facilitate overall understanding of the present invention, like numbers refer to like elements throughout the description of the drawings, and description of the same component will not be reiterated.

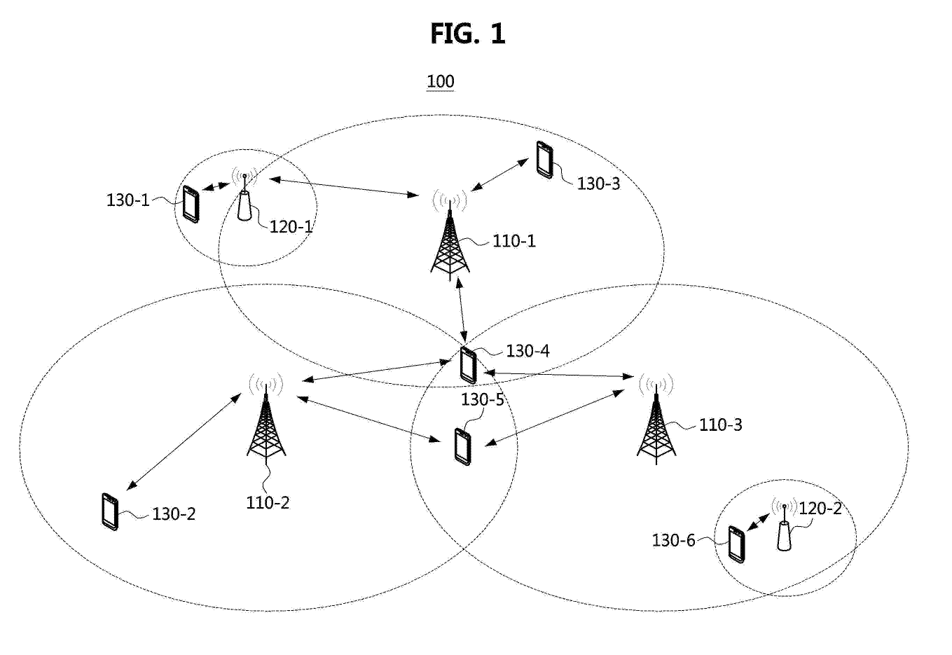

FIG. 1 is a conceptual diagram illustrating a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may also be referred to as a ‘communication network’. Each of the plurality of communication nodes may support at least one communication protocol. For example, each of the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, and a space division multiple access (SDMA) based communication protocol. Also, each of the plurality of communication nodes may have the following structure.

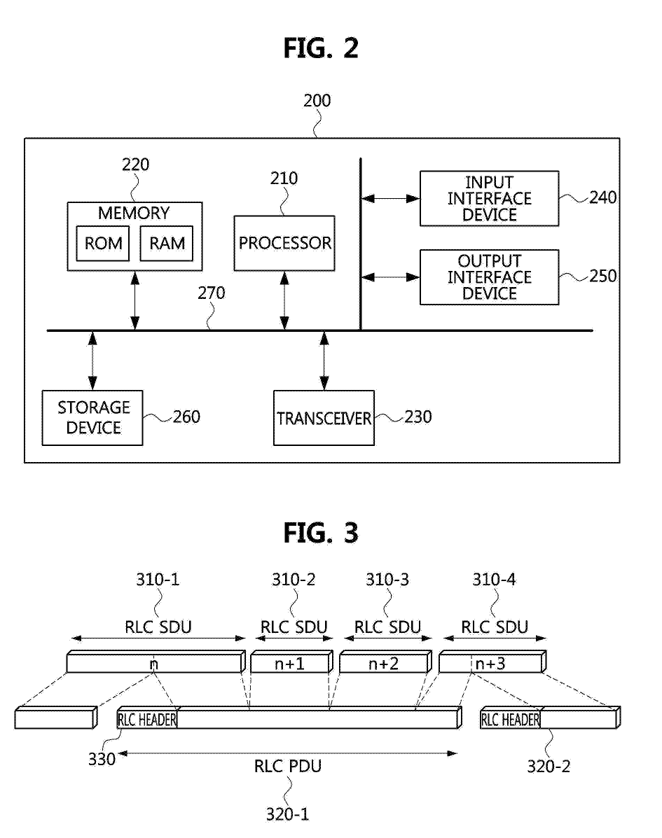

FIG. 2 is a block diagram illustrating a first embodiment of a communication node constituting a cellular communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270. However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a gNB, an ng-eNB, a base transceiver station (BTS), a radio base station, a radio transceiver, an access point, an access node, a road side unit (RSU), a radio remote head (RRH), a transmission point (TP), a transmission and reception point (TRP), a flexible TRP (f-TRP), gNB, a relay node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, a device supporting internet of things (IoT) functions, a mounted module/device/terminal, an on-board unit (OBU), or the like.

Each of the plurality of communication nodes 110-1, 110-2, 110-3, 120-1, 120-2, 130-1, 130-2, 130-3, 130-4, 130-5, and 130-6 may support the cellular communication (e.g., long-term evolution (LTE), LTE-Advanced (LTE-A), or the like defined in the 3^{rd} generation partnership project (3GPP) standards). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink transmissions and SC-FDMA-based uplink transmissions. Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner. The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Next, techniques for retransmission in an RLC layer will be described. Here, even when a method (e.g., transmission or reception of a signal) to be performed in a first communication node among communication nodes is described, a corresponding second communication node may perform a method (e.g., reception or transmission of the signal) corresponding to the method performed in the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

In the 3GPP LTE and LTE-A wireless communication systems, retransmission of data lost or having an error is mainly handled by a HARQ scheme of a MAC layer and is performed by a retransmission function of an RLC layer. The reason why the retransmission scheme through two layers is used is for a trade-off between speed and reliability of the status reporting feedback. The HARQ scheme is aimed at very fast retransmissions, so that after every transmission, a result of decoding for the corresponding data is fed back to a transmitting apparatus. Such the HARQ feedback performed in each transmission data unit plays a large role in reducing and error rate, but has drawbacks in terms of transmission power consumption and the like. On the other hand, an RLC status report performed in the RLC layer is transmitted relatively less frequently than the MAC layer HARQ scheme, thereby reducing the error rate. Therefore, the retransmission scheme through both the MAC layer and the RLC layer is a structure into which the two advantages of the fast retransmission of HARQ and the reliable data transmission of the RLC are combined. Particularly, the RLC layer receives data in form of an RLC service data unit (SDU) from an upper layer (e.g., a packet data convergence protocol (PDCP)), and transfers the data to the corresponding RLC entity of a receiving apparatus via the MAC layer and a physical layer. A plurality of logical channels in the RLC layer are multiplexed into one transport channel in the MAC layer, which is mainly used for downlink and uplink scheduling and priority handling. Next, an RLC PDU generation method in the RLC layer will be described.

FIG. 3 is a conceptual diagram for explaining a conventional method of generating an RLC PDU in an RLC layer.

Referring to FIG. 3, RLC SDUs transferred from an upper layer may be generated as RLC PDUs having different sizes. Generally, there may be one RLC entity per logical channel configured in one transmitting apparatus (e.g., terminal or base station), and the RLC entity may be responsible for the following roles.
Segmentation, concatenation, and reassembly of the RLC SDU
RLC retransmission
In-sequence delivery that orders data for the corresponding logical channel

The in-sequence delivery means a procedure for transferring data blocks such as RLC SDUs to the upper and lower layers in the order in which they were transmitted. In case of the HARQ scheme, since the data is operated independently and may be transferred to the receiving apparatus as their order is reversed, the RLC layer may perform a role of ordering the data.

The purpose of segmentation and concatenation is to generate RLC PDUs having appropriate sizes from the incoming RLC SDUs. The segmentation and concatenation are performed to generate RLC PDUs having variable sizes so that the RLC PDUs do not have too small or too large fixed PDU sizes. In order to support various quality communication services considering a radio channel state in the wireless communication system, the size of a transmission block, which is a payload transmitted through a subframe of the physical layer, is required to be changed according to the radio channel state and the communication service. For this, the RLC PDUs may be generated in various sizes through segmentation and concatenation, and then transferred to the lower layer. Also, the reassembly means a procedure for re-creating the RLC SDUs from the RLC PDUs received at the receiving apparatus.

As show in FIG. 3, the RLC SDUs 310-1, 310-2, 310-3, and 310-4 having different sizes transferred from the upper layer may be segmented and concatenated by the RLC entity, so that RLC PDUs 320-1 and 320-2 having various sizes and including an RLC header 330. The RLC header 330 may include a sequence number and other control information fields used for reordering and retransmission of the data such as PDUs. A retransmission request for the missing PDUs during the wireless transmission and reception may be a main function of the RLC layer of the receiving apparatus. The missing PDUs may be determined by checking the sequence numbers in the RLC headers 330 of the received PDUs, and retransmission may be requested to the transmitting apparatus.

On the other hand, each communication service to be provided in the wireless communication system may require a different data quality. For example, in a service that transmits a large file, perfect error-free delivery may be important, but in a streaming service such as video calls, the loss of some packets or the occurrence of errors in some packets may not be a significant problem. Considering these points, the RLC layer may operate in one of the following three modes according to the requirements of the application layer.

1) Transparent mode (TM): The RLC layer is completely transparent. Basically, the RLC layer passes data received from the upper layer without any action. There is no retransmission due to missing data, no segmentation and reassembly, and no in-sequence delivery. In general, this mode may be applied to data transmission through a broadcast channel in which information such as a broadcast control channel (BCCH) is transmitted to a plurality of terminals. The data size in this case may be selected so that the corresponding data can be reached with a high probability to all intended receiving apparatuses (terminals). That is, there is no need to segmentation to handle a variety of information, and no retransmission is required for error-free data transmission. Also, in this case, since the terminal has not yet established an uplink with the base station, the terminal cannot feed back its reception state, so that data cannot be retransmitted in the transparent mode.

2) Unacknowledged mode (UM): In this mode, segmentation/reassembly and in-sequence delivery are supported, but retransmission is not supported. This mode may be applied when error-free transmission is not required.

3) Acknowledged mode (AM): This mode is a main operation mode for transmission of transmission control protocol/internet protocol (TCP/IP) packet data over a downlink shared channel (DL-SCH), and supports segmentation, reassembly, in-sequence delivery, and retransmission of erroneous data. The acknowledged mode may be applied to a case where data is transmitted and received in both directions between corresponding RLC entities in both sides of the transmitting and receiving apparatuses. Since an acknowledgment of the normal reception in the receiving apparatus of the RLC PDUs transmitted by the transmitting apparatus should be transmitted to the RLC entity transmitting the RLC PDUs, bidirectional data transmission and reception is required. Information for retransmission of RLC PDUs not successfully received by the receiving apparatus may be transmitted from the receiving apparatus to the transmitting apparatus in a form called the status report described above. The status report information may be transmitted automatically by the receiving apparatus, or may be requested by the transmitting apparatus. Next, data transmission and retransmission in the RLC layer will be described.

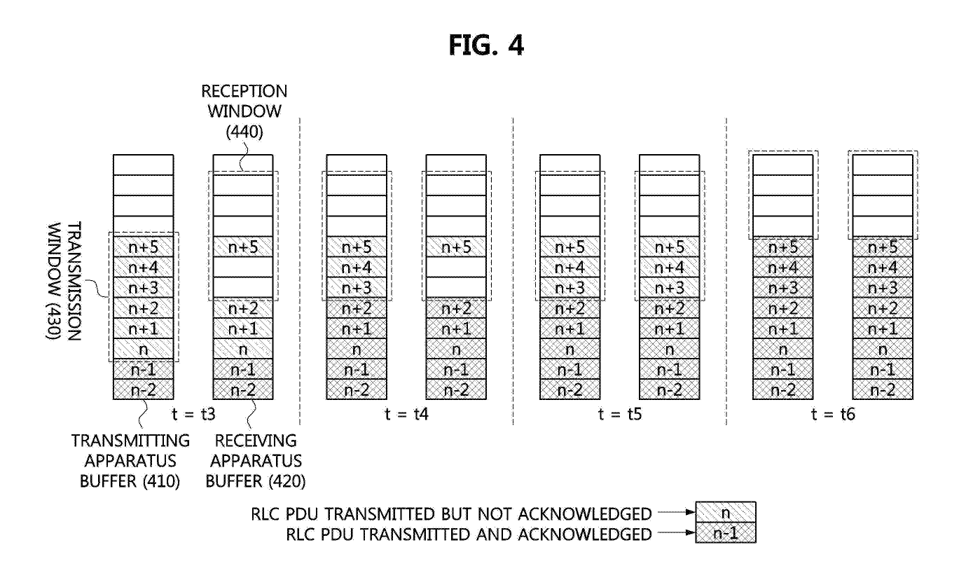

FIG. 4 is a conceptual diagram for explaining a conventional method of retransmitting data in an RLC layer.

Referring to FIG. 4, illustrated are data transmission and retransmission using a transmission window 430 of a transmitting apparatus buffer 410 and a reception window 440 of a receiving apparatus buffer 420 of an RLC layer. The RLC entities of the transmitting apparatus and the receiving apparatus may have the transmission window 430 and the reception window 440, respectively. Only RLC PDUs within the transmission window may be transmitted to the receiving apparatus. Similarly, the receiving apparatus may accept only RLC PDUs whose sequence numbers are within the reception window. The transmitting apparatus buffer 410 may be a data buffer in which RLC PDUs required to be transmitted or retransmitted to the receiving apparatus are temporarily stored. The data buffer may be implemented as separated into a transmission buffer and a retransmission buffer. However, hereinafter, an example in which the transmission buffer and the retransmission buffer are integrally configured will be described. The receiving apparatus buffer 430 may also be a data buffer in which RLC PDUs transmitted or retransmitted from the transmitting apparatus are temporarily stored.

Referring to FIG. 4 showing an example of the retransmission operation of the RLC layer, a total of 6 RLC PDUs (RLC PDUs of the sequence numbers n to (n+5)) in the transmitting apparatus buffer may be transmitted to the receiving apparatus at the time t3 (t=t3). Only the RLC PDUs with the sequence numbers n, (n+1), (n+2), and (n+5) arrive at the receiving apparatus buffer 420 of the receiving apparatus, and the RLC PDUs with the sequence numbers (n+3) and (n+4) are missing. The receiving apparatus may start a reordering timer (not shown) for the missing PDUs. When the missing RLC PDU is not received until the reordering timer expires, retransmission may be requested. In the example of FIG. 4, the receiving apparatus starts the reordering timer because the RLC PDU with the sequence number (n+3) and the RLC PDU with the sequence number (n+4) are missing. However, no RLC PDUs arrives before the reordering timer expires (t=t4). At the time t4 (t=t4), the reordering timer may expire, and the receiving apparatus may transmit control PDUs including status report information informing the missing RLC PDUs (i.e., the RLC PDU with the sequence number (n+3) and the RLC PDU with the sequence number (n+4)) to the corresponding entity. Upon receiving the status report information at the time t5 (t=t5), the transmitting apparatus may identify that the RLC PDUs up to the sequence number (n+2) have been normally transmitted to the receiving apparatus, and may move the transmission window 430 accordingly. Also, the missing RLC PDUs with the sequence numbers (n+3), (n+4), and (n+5) may be retransmitted.

Finally, at the time t6 (t=t6), all RLC PDUs including the retransmitted RLC PDUs have been transmitted by the transmitting apparatus and successfully received at the receiving apparatus. Since the RLC PDU with the sequence number (n+5) is the last RLC PDU in the transmitting apparatus buffer 410, the transmitting apparatus may request status report information to the receiving apparatus by setting a flag (e.g., a poll bit=1) in a header of the last RLC PDU. The receiving apparatus receiving the RLC PDU with the poll bit set to 1 may transmit the requested status report to the transmitting apparatus, and perform an acknowledgment response for the status report information for all the RLC PDUs up to the sequence number n+5. The acknowledgement response may indicate information about which RLC PDU was successfully received and information about which RLC PDUs are missing or erroneous. The transmitting apparatus may receive the status report information, determine whether all the RLC PDUs are normally transmitted, and retransmit the missing RLC PDUs.

As described above, the status report may be generated according to a plurality of different reasons. However, if the status report is generated too frequently, transmission latency and resource depletion may be caused by the frequent generation of the status report. In order to prevent the transmission latency and resource depletion, a status prohibition timer may be used. Using the status prohibition timer, the status report may be prohibited from being transmitted more than once within a time period predetermined by the status prohibition timer. Meanwhile, unlike the retransmission according to the status report from the receiving apparatus, when a data transmission error is notified to the RLC layer of the receiving apparatus according to the HARQ protocol of the transmitting apparatus, the retransmission of the missing RLC PDU may be performed by the RLC layer immediately without waiting for the explicit status report from the receiving apparatus.

In case of initial transmission, it is easy to create a PDU having a variable size for various data rates. However, when the data is retransmitted, the radio channel condition and the amount of available radio resources may change. In order to cope with such the change, the segmentation may be performed when retransmitting the already-transmitted RLC PDU. That is, all of the segments of the RLC PDU are required to be transmitted in order to complete transmission of the RLC PDU. The status report and the retransmission may be separately applied to each of the RLC PDU segments, and only the missing RLC PDU segment not the entire RLC PDU may be retransmitted. Next, the segmentation of the RLC PDU will be described.

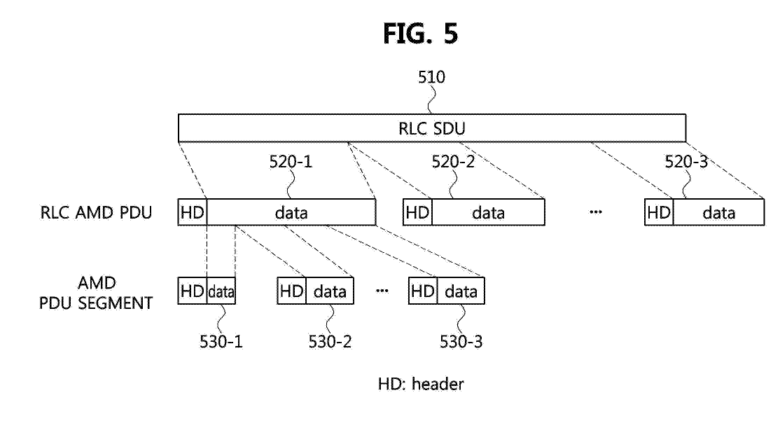

FIG. 5 is a conceptual diagram for explaining a conventional method for segmenting an RLC PDU.

Referring to FIG. 5, a plurality of RLC PDUs may be generated by segmenting an RLC SDU transferred from the upper layer into an appropriate size according to a size of radio resources allowed in a specific transmission time interval (TTI).

Hereinafter, an RLC PDU transmitted in the acknowledged mode may be referred to as an acknowledged mode data packet data unit (AMD PDU). When there is not enough available radio resources at the retransmission time of the AMD PDU, the corresponding AMD PDU may be retransmitted as segmented into a small size and configured as a plurality of AMD PDU segments. In an example of FIG. 5, the RLC SDU 510 may be segmented into 3 AMD PDUs 520-1, 520-2, and 520-3 according to the size of radio resources available in the corresponding TTI. Such the operation may be performed until all the data constituting the RLC SDU 510 can be transmitted to the receiving apparatus through the lower layer. Here, when transmission of a specific AMD PDU (e.g., the AMD PDU 520-1) fails and retransmission of the specific AMD PDU 520-1 is needed, the corresponding AMD PDU 520-1 may be retransmitted with the same size as it is. However, the size of the allowed radio resources may be insufficient to retransmit the entire AMD PDU at the desired time of the retransmission. In this case, the data in the AMD PDU 520-1 to be retransmitted may be transmitted as segmented into a plurality of segments. These may be referred to as the AMD PDU segments. In FIG. 5, a case where the AMD PDU 520-1 to be retransmitted is segmented into 3 AMD PDU segments 530-1, 530-2, and 530-3. Next, a data transmission control procedure in the RLC layer will be described.

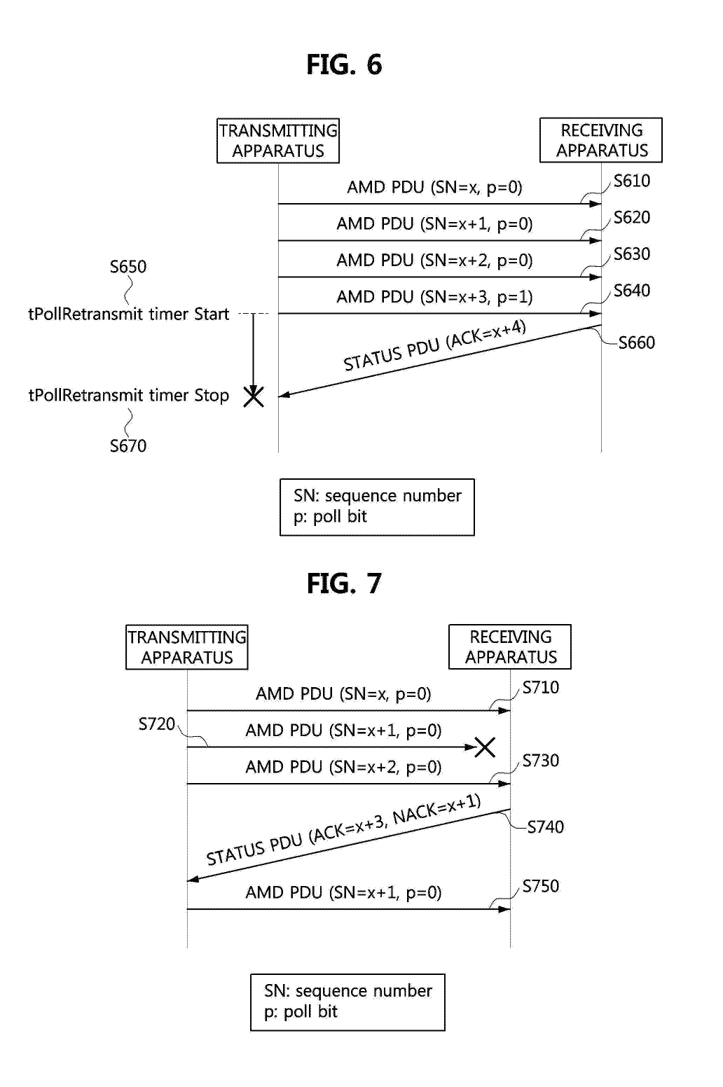

FIG. 6 is a sequence chart illustrating a conventional method of transmitting an AMD PDU.

Referring to FIG. 6, a total of 4 consecutive AMD PDUs are stored in a data buffer (including a transmission buffer and a retransmission buffer) of a transmitting apparatus, and these AMD PDUs are transmitted to a receiving apparatus. The sequence numbers (SN) of the AMD PDUs may correspond to x to (x+3). When there is no more data remaining in the data buffer at the time of transmitting an AMD PDU, a poll bit (p) for the AMD PDU (e.g., the AMD PDU (x+3)) may be set (i.e., p=1). The transmitting apparatus may start a timer for determining a retransmission after transmitting the AMD PDU (x+3) with the set poll bit. When the receiving apparatus receives the AMD PDU (x+3) with the set poll bit, the receiving apparatus may transmit a status report (i.e., STATUS PDU) to the transmitting apparatus for status reporting. The STATUS PDU for the status reporting may include sequence numbers of AMD PDUs that the receiving apparatus has received so far or failed to receive.

Referring to FIG. 6, a total of 4 AMD PDUs may be transmitted to the receiving apparatus. An AMD PDU having the sequence number x may be transmitted to the receiving apparatus (specifically, the RLC entity of the receiving apparatus) by the transmitting apparatus (specifically, the RLC entity of the transmitting apparatus) (S610). At this time, since the AMD PDU x is not the last transmitted AMD PDU, it may be transmitted as the poll bit for it is not set (i.e., p=0). Then, the transmitting apparatus may transmit the AMD PDUs (x+1) and (x+2) to the receiving apparatus while increasing the sequence number (i.e., SN=(x+1), SN=(x+2)) without setting the poll bits for them (S620, S630). Since the transmitting apparatus is required to transmit the last AMD PDU (x+3), the transmitting apparatus may transmit the AMD PDU having the set poll bit (i.e., p=1) and corresponding to the last sequence number (SN=(x+3)) to the receiving apparatus (S630). At this time, the transmitting apparatus may start a timer (i.e., a retransmission timer (e.g., tPollRetransmit timer)) for determining whether to retransmit the AMD PDU having the set poll bit (S650).

The receiving apparatus receiving the AMD PDU with the set poll bit may transmit a status report (i.e., STATUS PDU) to the transmitting apparatus in order to report a reception status of the AMD PDUs received so far (S660). The STATUS PDU may include information on a sequence number of the AMD PDU having been normally received, a sequence number of the AMD PDU having failed to be received, and a sequence number of the AMD PDU to be received next. In the example shown in FIG. 6, since the receiving apparatus has normally received all the AMD PDUs, a status report (i.e., STATUS PDU) including only the sequence number of the AMD PDU to be received next may be transmitted. That is, the receiving apparatus may transmit a status report (i.e., STATUS PDU) indicating that the sequence number of the AMD PDU to be transmitted next is (x+4) to the transmitting apparatus (S660). Upon receiving the status report (i.e., STATUS PDU) in the transmitting apparatus, the retransmission timer (tPollRetransmit timer) may be stopped (S670). Accordingly, the transmitting apparatus may regard the AMD PDUs having the sequence numbers x to (x+3) as having been normally transmitted to the receiving apparatus. Next, a retransmission procedure of a missing AMD PDU will be described.

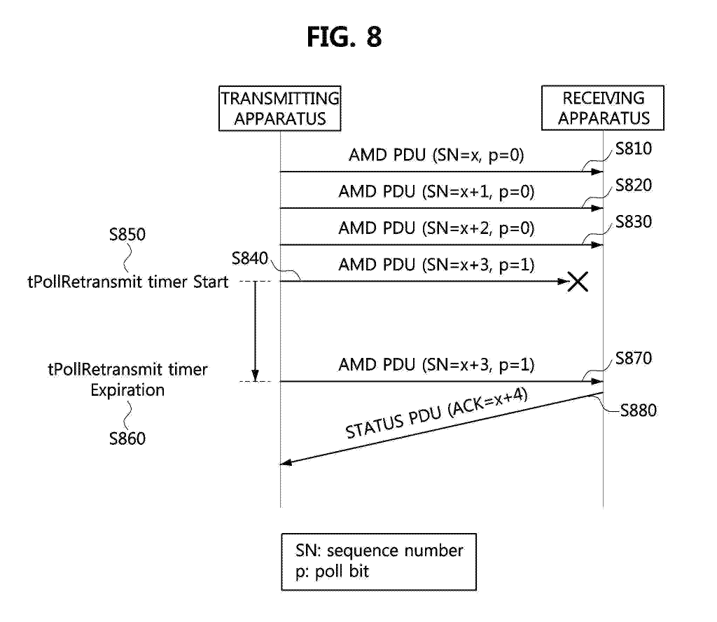

FIG. 7 is a sequence chart for explaining a conventional method of retransmitting an AMD PDU using a status report, and FIG. 8 is a sequence chart for explaining a conventional method of retransmitting an AMD PDU using a retransmission timer.

FIG. 7 shows a retransmission control procedure by transmission of a status report (i.e., STATUS PDU) of a receiving apparatus. In general, retransmission of an AMD PDU may be performed when the transmitting apparatus receives a status report (STATUS PDU) indicating the AMD PDU required to be retransmitted from the receiving apparatus or when the retransmission timer (i.e., tPollRetransmit timer) expires in the transmitting apparatus. The transmitting apparatus may transmit an AMD PDU having a sequence number x (i.e., SN=x) (S710), and then transmit an AMD PDU having a sequence number (x+1) (i.e., SN=(x+1)) (S720). However, it may be assumed that the AMD PDU having the sequence number (x+1) has not been normally transmitted to the receiving apparatus. Subsequently, the transmitting apparatus may transmit an AMD PDU having a sequence number (x+2) (i.e., SN=(x+2)) (S730). The receiving apparatus receiving the AMD PDU having the sequence number (x+2) (i.e., SN=(x+2)) may determine that the AMD PDU having the sequence number (x+1) is missing, and transmit a status report (i.e., STATUS PDU) to the transmitting apparatus (S740). The STATUS PDU may include information indicating the sequence number (x+3) of the AMD PDU to be received next (i.e., ACK=(x+3)) and information indicating the sequence number (x+1) of the missing AMD PDU (i.e., NACK=(x+1)). Upon receiving the status report (i.e., STATUS PDU), the transmitting apparatus may retransmit the AMD PDU having the sequence number (x+1) (S750). That is, this case may be an example where status information is given to the transmitting apparatus by the receiving apparatus's own determination regardless of the setting of the poll bit of the received AMD PDU. Next, a retransmission procedure of the AMD PDU using the retransmission timer will be described.

Referring to FIG. 8, there is shown an AMD PDU retransmission procedure by expiration of a retransmission timer (i.e., tPollRetransmit) in a transmitting apparatus. The transmitting apparatus may continuously transmit AMD PDUs whose sequence numbers sequentially increase (i.e., SN=x, (x+1), (x+2)) to the receiving apparatuses (S810, S820, S830). These AMD PDUs may be transmitted with their poll bits not set (i.e., p=0). Then, the AMD PDU having the sequence number (x+3) may be transmitted while informing that it is the last AMD PDU (i.e., p=1) (S840). The transmitting apparatus transmitting the AMD PDU with the set poll bit may start the retransmission timer (i.e., tPollRetransmit timer) (S850). Here, it may be assumed that the AMD PDU having the sequence number (x+3) has not been normally transmitted to the receiving apparatus. When the AMD PDU with the set poll bit is not delivered to the receiving apparatus, the receiving apparatus may wait indefinitely without status reporting. This may be a problem especially in the case of intermittently transmitting data as in the case of the narrow band Internet of things (NB-IoT) to be described later.

In order to cope with such the case, when the transmitting apparatus does not receive the status report from the receiving apparatus until the expiration of the retransmission timer (S860), the transmitting apparatus may determine that the AMD PDU having the sequence number (x+3) has not been normally transmitted. At this time, when a new AMD PDU to be transmitted is not input to the data buffer and an AMD PDU required to be retransmitted is not input to the data buffer in the previous procedure, the AMD PDU with the sequence number (x+3) may be transmitted again (S870). Since the receiving apparatus receives the AMD PDU with the set poll bit (i.e., p=1) and all the previous AMD PDUs have been normally received, the receiving apparatus may transmit a status report (i.e., STATUS PDU) including the sequence number (x+4) of the AMD PDU to be transmitted next (i.e., ACK=(x+4)) to the transmitting apparatus (S880). Next, retransmission of an AMD PDU segment will be described.

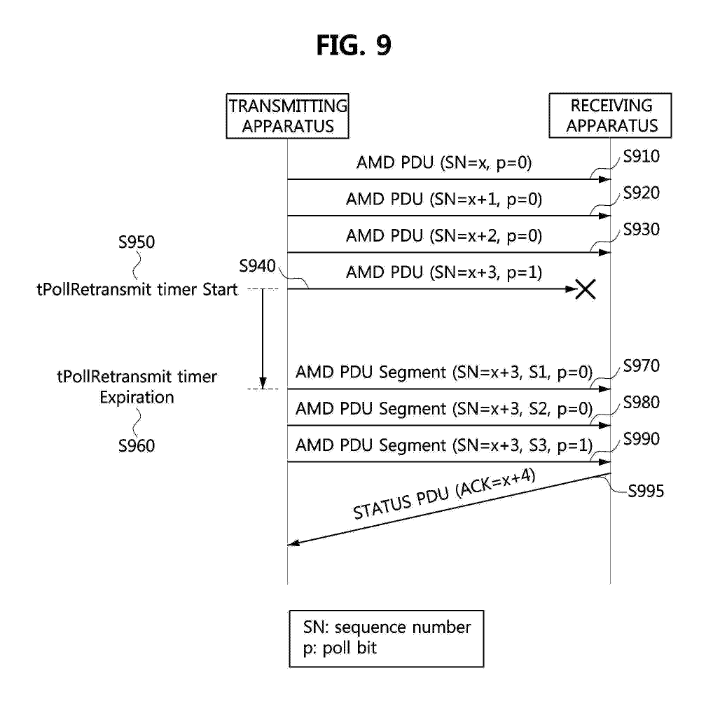

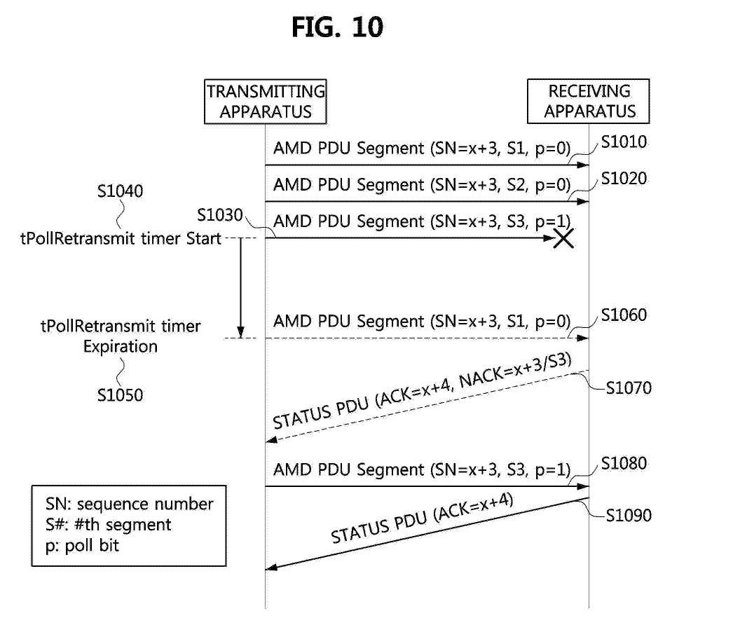

FIG. 9 is a sequence chart for explaining a conventional method of retransmitting an AMD PDU segment. FIG. 10 is a sequence chart for explaining another conventional method of retransmitting an AMD PDU segment.

Referring to FIG. 9, retransmission may be performed based on AMD PDU segments when the retransmission is performed according to expiration of a retransmission timer set by the transmitting apparatus.

A total of 4 AMD PDUs sequence numbers of which are increased from x to (x+3) may be transmitted sequentially from the transmitting apparatus to the receiving apparatus (S910 to S940). Here, since the AMD PDU having the sequence number (x+3) is the last AMD PDU, the AMD PDU having the sequence number (x+3) may be transmitted with its poll bit set. Since the poll bit is set, the transmitting apparatus may start a retransmission timer (i.e., tPollRetransmit timer) at the same time of transmission (S950).

Since the transmitting apparatus has not received a status report (i.e., STATUS PDU) as a response to the AMD PDU with the set poll bit from the receiving apparatus until the expiration of the retransmission timer (S960), the transmitting apparatus may not determine which AMD PDU has been transmitted to the receiving apparatus or which AMD PDU has not been transmitted to the receiving apparatus. Accordingly, when a new AMD PDU arrived in the data buffer is not input and retransmission data for the AMD PDU transmitted in the previous procedure is not input, the transmitting apparatus may attempt to retransmit the AMD PDU with the set poll bit. However, when it is difficult to transmit the entire AMD PDU due to insufficient available radio resources at the retransmission time, the AMD PDU may be retransmitted as segmented into a plurality of segments.

In the example of FIG. 9, the AMD PDU having the sequence number (x+3) required to be retransmitted may be retransmitted as divided into 3 segments. One of the AMD PDU segments may also indicate whether it is the last segment by setting the poll bit on a segment-by-segment basis. The transmitting apparatus may divide the AMD PDU having the sequence number (x+3) into 3 segments S1, S2 and S3 in total, and transmit the first segment S1 (S970). Here, the poll bit for S1 is not set (i.e., p=0) because it is not the last segment. Then, the second segment S2 of the AMD PDU having the sequence number (x+3) may be transmitted to the receiving apparatus (S980), and the last segment S3 with the set poll bit (i.e., p=1) may be transmitted to the receiving apparatus (S990). The receiving apparatus having received all three segments including the AMD PDU segment having the set poll bit may transmit a status report (i.e., STATUS PDU) for reporting to the transmitting apparatus (S995). Since the 4 AMD PDUs have been normally received, the status report (i.e., STATUS PDU) may further include information indicating the sequence number (x+4, i.e., ACK=(x+4)) of the next AMD PDU to be transmitted.

Referring to FIG. 10, when the AMD PDU segment with the set poll bit is missing, a retransmission timer may be used to retransmit the missing AMD PDU segment. When the transmitting apparatus retransmits the AMD PDU having the sequence number (x+3) to the receiving apparatus, the transmitting apparatus may segment the AMD PDU into 3 segments S1, S2 and S3, the first segment S1 may be transmitted (S1010). Since it is not the last AMD PDU segment, the poll bit for S1 is not set (p=0). Then, the second AMD PDU segment S2 may be transmitted (S1020), and the last AMD PDU segment S3 with the set poll bit (p=1) may be transmitted (S1030).

The transmitting apparatus may transmit the last AMD PDU segment with the set poll bit, and start the retransmission timer (i.e., tPollRetransmit timer) (S1040). The transmitting apparatus that has not received a status report (i.e., STATUS PDU) until the retransmission timer expires may retransmit the corresponding AMD PDU, when a new AMD PDU or an AMD PDU having a previous sequence number and required to be retransmitted is not input to the data buffer. In this case, the first AMD PDU segment S1 may be retransmitted (S1060). The receiving apparatus that has already received the first AMD PDU segment S1 may transmit to the transmitting apparatus a status report including information indicating the AMD PDU segments that have been normally received so far (or, information indicating the AMD PDU segments that have not been normally received) and information indicating the sequence number (x+4) of the next AMD PDU to be transmitted (S1070).

The transmitting apparatus receiving the status report (i.e., STATUS PDU) may transmit only the third AMD PDU segment S3, which is the abnormally-transmitted AMD PDU segment, to the receiving apparatus (S1080). The receiving apparatus normally receiving the AMD PDU segment with the set poll bit may transmit a status report (i.e., STATUS PDU) including a sequence number of the AMD PDU to be transmitted next to the transmitting apparatus (S1090). That is, when retransmitting all the AMD PDU segments due to the missing of some AMD PDU segment, the normally-received AMD PDU segment may be also retransmitted and the status report (i.e., STATUS PDU) may be transmitted several times, so that a large transmission latency may occur.

Particularly, in the case of NB-IoT, which is attracting attention in the 5G mobile communication system, radio resources are very limited and available radio resources may be limited. Therefore, efficient use of radio resources is required for a case of data loss occurring between the NB-IoT devices or between the NB-IoT device and an NB-IoT base station due to a poor radio environment.

The NB-IoT is a narrow-band wireless communication technology suitable for a small thing Internet where IoT devices such as smart meters, sensors, etc. transmit small amounts of data intermittently. A physical resource block (PRB) corresponding to a 180 kHz frequency bandwidth is used as a radio resource, and the size of data that can be transmitted in one transmission time interval (TTI) is limited to about 100 bytes. For example, in the release 13 of 3GPP, the NB-IoT uplink transport block size (TBS) is defined as 125 bytes (i.e., 1,000 bits) and the downlink maximum TBS is defined as 85 bytes (i.e., 680 bits). As seen from the above, the NB-IoT is limited in radio resources, and in general, data retransmission occurs in a situation where a radio environment of the radio channel section is deteriorated. Therefore, in the procedure of retransmitting an AMD PDU (or AMD PDU segments), unnecessary overheads should be prevented in advance.

However, since the conventional method of retransmitting an AMD PDU shown in FIG. 10 also retransmits the AMD PDU segments normally received by the receiving apparatus, there may be a problem of wasting radio resources due to the transmission of incidental status report of the receiving apparatus. Also, since the entire AMD PDU including the segments that are not missing is redundantly retransmitted even though retransmission of only some AMD PDU segments is required, there may be a problem of unnecessary overheads due to the redundant AMD PDU reception and status report (i.e., STATUS PDU) at the receiving apparatus.

In particular, as described above, when the receiving apparatus recognizes a gap (i.e., SN gap) between the sequence numbers of the received AMD PDUs, the receiving apparatus may determine that an AMD PDU has been lost, and request retransmission of the lost AMD PDU by transmitting a status report (i.e., STATUS PDU) to the receiving apparatus. However, in the NB-IoT, transmission of AMD PDUs from the transmitting apparatus is intermittent, so that if the last transmitted AMD PDU is lost in the radio channel, it is difficult for the receiving apparatus to detect it. In order to solve this problem, the transmitting apparatus may determine whether to retransmit the AMD PDU according to whether the retransmission timer expires. Also, since the retransmission timer has a generally long duration, when the retransmission is determined based on the expiration of the retransmission timer of the transmitting apparatus, there may be a problem that a latency occurs until the retransmission starts. Next, an AMD PDU segment retransmission method according to an embodiment of the present disclosure for preventing the waste of radio resources will be described.

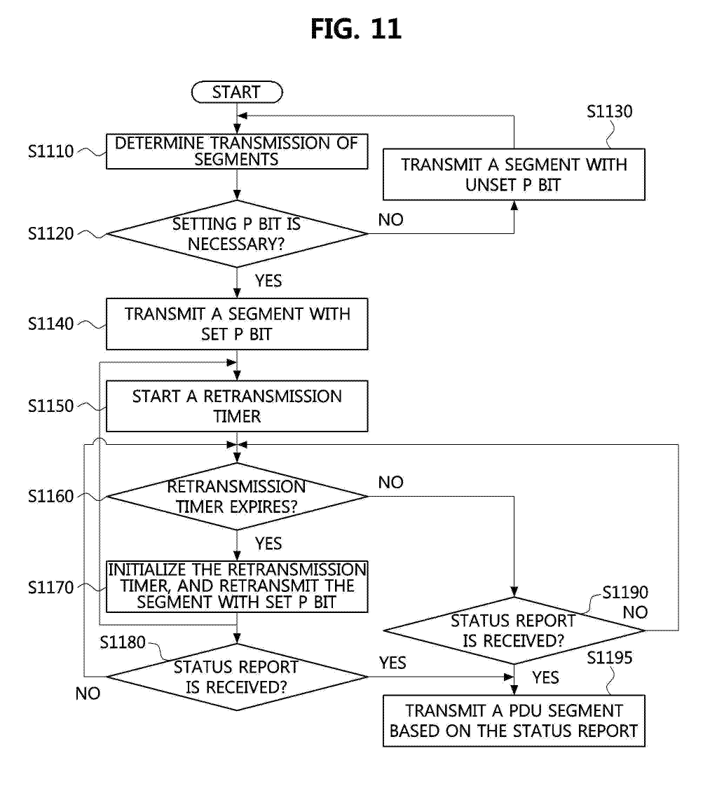

FIG. 11 is a sequence chart for explaining a method of retransmitting an AMD PDU segment according to an embodiment of the present disclosure.

Referring to FIG. 11, in the case that the transmitting apparatus segments and transmits an AMD PDU, when the retransmission timer expires, only a missing segment with a set poll bit may be retransmitted. In the following embodiments of the present disclosure, the transmitting and receiving apparatuses transmitting and receiving the AMD PDU (including the AMD PDU segments) may refer to as the RLC entities of the transmitting and receiving apparatuses. FIG. 11 illustrates a sequence chart according to an embodiment of the present disclosure for a case where the transmitting apparatus divides an AMD PDU into multiple AMD PDU segments, and transmits and retransmits the AMD PDU segments due to a lack of radio resources while transmitting the AMD PDU on a slot basis to the receiving apparatus. The AMD PDU may be determined to be segmented and transmitted from the transmitting apparatus (S1110). Such the determination may be made by the RLC entity or a unit that controls radio resource management and/or transmission such as a scheduler for managing radio resource allocation and the like. The AMD PDU segments are sequentially transmitted according to the order of the segment numbers assigned to the AMD PDU segments. Since the last AMD PDU segment is required to be transmitted after setting its poll bit (i.e., p=1), it may be determined whether a segment to be transmitted is the last segment of the corresponding AMD PDU (S1120).

Each of the segments, which is not the last segment, may be transmitted to the receiving apparatus as its poll bit is not set (i.e., p=0) according to the order indicated by the sequence number of it (S1130). On the other hand, the last segment of the corresponding AMD PDU may be transmitted to the receiving apparatus as its poll bit is set (i.e., p=1) together with its AMD PDU sequence number and its segment number (S1140). When the last segment is transmitted, the retransmission timer may be started (activated) simultaneously with transmission (S1150).

When the retransmission timer expires and a new AMD PDU and/or an AMD PDU required to be retransmitted with a previous sequence number is not input in the data buffer, the retransmission timer may be initialized, and the last segment (i.e., with p set to 1) of the AMD PDU transmitted in the previous step may be retransmitted to the receiving apparatus (S1170). The data buffer may include a transmission buffer in which a new AMD PDU is stored and a retransmission buffer in which an AMD PDU required to be retransmitted is stored.

At the same time as the retransmission, the retransmission timer may be started (S1150). Thereafter, it may be checked whether a status report is received from the receiving apparatus (S1180). If a status report is not yet received, the transmitting apparatus may return to the step of determining whether the retransmission timer expires (S1160). The status report may include a sequence number of an AMD PDU to be received next by the receiving apparatus, information on reception states of AMD PDUs that have been received at the receiving apparatus but have not been reported yet, information on reception states of AMD PDU segments that have been received or have not been received, or the like. When the retransmission timer does not expire, it may be continuously checked whether the status report is received from the receiving apparatus (S1190). When the status report is still not received, the transmitting apparatus may return to the step of determining whether the retransmission timer expires (S1160). When the status report is received from the receiving apparatus, information on the sequence number and the segment number of the normally-received AMD PDU segment and/or the sequence number and the segment number of the abnormally-received AMD PDU segment may be derived therefrom, and the AMD PDU and the segment may be transmitted or retransmitted (S1195). Next, a detailed procedure of retransmitting an AMD PDU segment according to an embodiment of the present disclosure will be described.

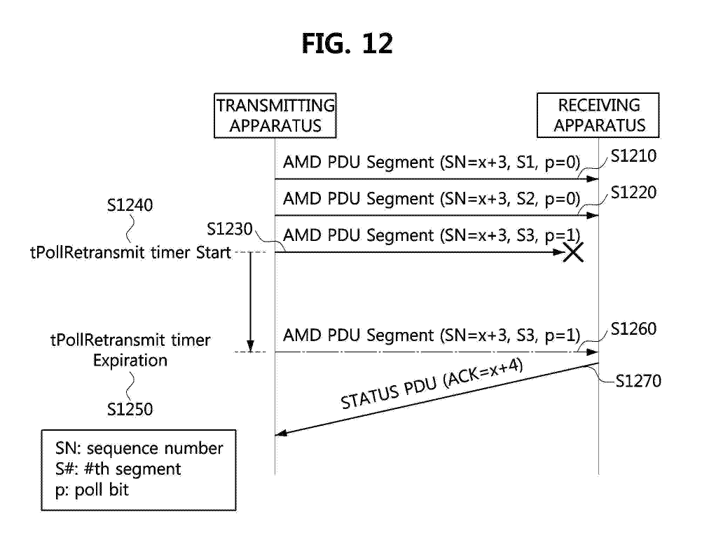

FIG. 12 is a sequence chart for explaining a method of retransmitting an AMD PDU segment according to another embodiment of the present disclosure. Referring to FIG. 12, when a segment of the AMD PDU divided into segments, which has a set poll bit (p bit), is lost, only the missing segment may be retransmitted unlike conventional scheme. That is, FIG. 12 illustrates a case that an AMD PDU having the sequence number (x+3) is transmitted as divided into 3 segments S1, S2 and S3 due to a reason such as a lack of radio resources when the AMD PDU is transmitted on a PDU basis. Hereinafter, the transmitting and receiving apparatuses for transmitting and receiving an AMD PDU (including an AMD PDU segment) in the embodiments of the present disclosure may refer to the RLC entities of the transmitting and receiving apparatuses.

Also, it is apparent to a person skilled in the art of the present disclosure that the embodiment of the present disclosure shown in FIG. 12 can be applied even when the sequence numbers and the number of segments are changed.

First, the first AMD PDU segment S1 may be transmitted from the transmitting apparatus to the receiving apparatus (S1210). Since it is not the last AMD PDU segment, the poll bit for S1 is not set (p=0). Then, the second AMD PDU segment S2 may be transmitted (S1220), and the last AMD PDU segment S3 with the poll bit is set (p=1) may be transmitted (S1230).

The transmitting apparatus may transmit the last AMD PDU segment S3 with the set poll bit, and start the retransmission timer (i.e., tPollRetransmit timer) (S1240). The transmitting apparatus that has not received a status report (i.e., STATUS PDU) which is a response to the set poll bit until the retransmission timer expires may retransmit the corresponding AMD PDU having the sequence number (x+3) determined as having not been normally transmitted, when a new AMD PDU or an AMD PDU having a previous sequence number required to be retransmitted is not input to the data buffer. The data buffer may include a transmission buffer in which a new AMD PDU is stored and a retransmission buffer in which an AMD PDU required to be retransmitted is stored.

In this case, only the last transmitted segment S3 may be retransmitted without retransmission from the first segment S1 of the AMD PDU having the same sequence number (x+3) unlike the conventional scheme (S1260). Accordingly, the transmitting apparatus does not transmit the previous segments S1 and S2 in order to receive the status report from the receiving apparatus. Thus, the receiving apparatus also may not transmit the status report, thereby preventing waste of unnecessary radio resources. Then, the receiving apparatus receiving the AMD PDU segment with the set poll bit may transmit a status report (i.e., STATUS PDU) to the RLC entity of the transmitting apparatus (S1270). The status report may include a sequence number of an AMD PDU to be received next by the receiving apparatus, information on reception states of AMD PDUs that have been received but have not been reported yet, information on reception states of AMD PDU segments that have been received or have not been received, or the like. The status report (i.e., STATUS PDU) of the embodiment shown in FIG. 12 includes only the sequence number of the next AMD PDU to be received. When the status report including only the sequence number of the AMD PDU to be received next is received, the transmitting apparatus may determine that all transmitted segments of the AMD PDU having the previous sequence number have been normally transmitted to the receiving apparatus. Next, a method for retransmitting an AMD PDU by using a reception timer of a receiving apparatus for preventing a latency occurring until the retransmission starts.

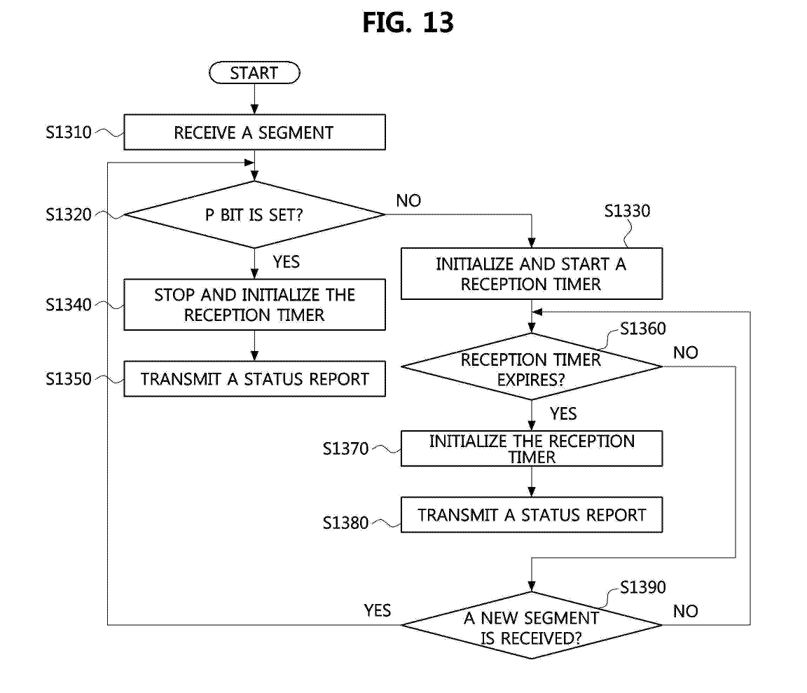

FIG. 13 is a sequence chart for explaining a method of retransmitting an AMD PDU segment using a reception timer according to an embodiment of the present disclosure.

Referring to FIG. 13, in the case that the transmitting apparatus segments and transmits an AMD PDU, when the reception timer of the receiving apparatus expires, the receiving apparatus may transmit a status report to the transmitting apparatus without a request of the receiving apparatus. The sequence chart shown in FIG. 13 illustrates an embodiment for a case when the RLC entity of the transmitting apparatus transmits an AMD PDU by dividing it into a plurality of AMD PDU segments due to a reason such as a lack of radio resources when transmitting it to the receiving apparatus.

First, the receiving apparatus may receive an AMD PDU segment transmitted from the transmitting apparatus (S1310). The receiving apparatus may determine whether the poll bit of the received segment is set or not (S1320). When the segment with an unset poll bit is received, the receiving apparatus may initialize and start a reception timer (S1330). On the other hand, when the segment with a set poll bit is received, the receiving apparatus may stop the reception timer and initialize the reception timer (S1340). When the reception timer is stopped and initialized, the receiving apparatus may transmit a status report to the receiving apparatus even when the segment with a set poll bit is not received from the transmitting apparatus (S1350). The status report may include a sequence number of an AMD PDU to be received next by the receiving apparatus, information on reception states of AMD PDUs that have been received but have not been reported yet, information on reception states of AMD PDU segments that have been received or have not been received, or the like.

After the receiving apparatus receives the segment with an unset poll bit, and initializes and starts (activates) the reception timer, if the reception timer expires (S1360), the receiving apparatus may initialize the reception timer again (S1370), and transmit a status report to the receiving apparatus (S1380). If the reception timer does not expire, the receiving apparatus may check whether a new AMD PDU segment is received (S1390). When a new AMD PDU segment is not received, the receiving apparatus may return to the step of checking whether the reception timer expires again (S1360). However, when a new AMD PDU segment is received, the receiving apparatus may again check whether the poll bit is set (S1320), and perform the operation and initialization of the reception timer, and transmission of a status report again. Such the determination and decision in the receiving apparatus may be performed by a unit for controlling radio resource allocations and/or transmissions such as a scheduler for managing radio resource allocations and the like. Next, a specific procedure for transmitting an AMD PDU segment using a reception timer according to an embodiment of the present disclosure will be described.

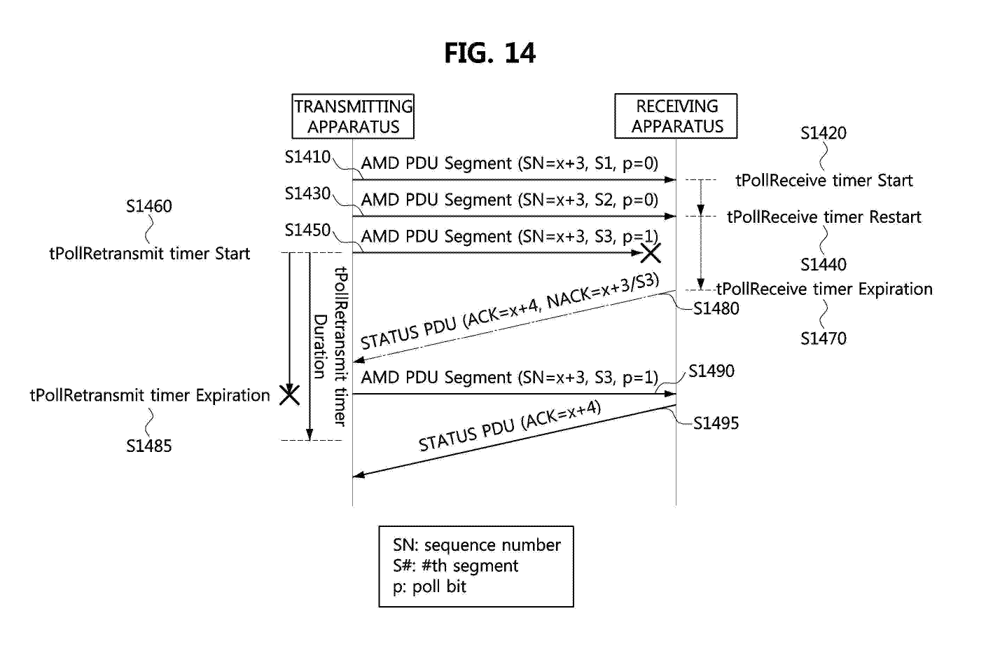

FIG. 14 is a sequence chart for explaining a method for retransmitting an AMD PDU using a reception timer according to an embodiment of the present disclosure.

Referring to FIG. 14, there is shown a retransmission procedure of an AMD PDU using a retransmission timer (i.e., tPollTransmit timer) in the transmitting apparatus and a reception timer (i.e., tPollReceive timer) in the receiving apparatus at the same time. When receiving an AMD PDU (or, AMD PDU segment) from the transmitting apparatus, the receiving apparatus may initialize and start (activate) the reception timer. Also, the receiving apparatus may initialize and restart (activates) the reception timer when the receiving apparatus receives an AMD PDU having the next sequence number (or, the next AMD PDU segment). When a new AMD PDU or AMD PDU segment is not received during the duration of the reception timer, the reception timer may expire, and the receiving apparatus may transmit a status report (i.e., STATUS PDU) to the transmitting apparatus. Such the status report may include a sequence number of the missing AMD PDU (or AMD PDU segment) and a sequence number of the next AMD PDU to be received. However, the duration of the reception timer may be shorter than the duration of the retransmission timer of the transmission apparatus (i.e., tPollRetransmit timer duration). Accordingly, it may be prevented that the RLC entity of the transmitting apparatus retransmits an AMD PDU (or, AMD PDU segment) by arbitrarily determine whether the AMD PDU (or, AMD PDU segment) is missing, so that the waste of radio resources can be prevented.

In the embodiment shown in FIG. 14, when an AMD PDU is transmitted on a PDU basis from the RLC entity of the transmitting apparatus to the RLC entity of the receiving apparatus, the AMD PDU is transmitted as divided into AMD PDU segments for transmission due to a reason such as a lack of radio resources. For example, the AMD PDU having the sequence number (x+3) is divided into a total of 3 segments S1, S2, and S3. It is apparent to a person skilled in the art of the present disclosure that the embodiment shown in FIG. 14 can be applied even when the sequence number and the number of segments are changed.

First, the first AMD PDU segment S1 may be transmitted (S1410). Since this AMD PDU segment S1 is not the last AMD PDU segment, the poll bit for S1 may not be set (i.e., p=0). The receiving apparatus receiving the first AMD PDU segment S1 may initialize and start (activate) the reception timer (S1420). Then, the second AMD PDU segment S2 may be transmitted (S1430), and the receiving apparatus receiving the second AMD PDU segment S2 may initialize and restart the reception timer (S1440). The transmitting apparatus may transmit the last segment S3 to the receiving apparatus while setting the poll bit of S3 (i.e., p=1) (S1450). The retransmission timer may be started while transmitting the last segment S3 of the AMD PDU (S1460). The retransmission timer duration (i.e., tPollRetransmit timer duration) may be longer than the reception timer duration (i.e., tPollReceive timer duration) as described above. When the last segment S3 is lost in the radio channel section during the transmission, the last segment S1 may not be received during the reception timer duration of the RLC entity of the receiving apparatus. In this case, when the configured reception time duration expires (S1470), the receiving apparatus may transmit status report (i.e., STATUS PDU) to the transmitting apparatus even without receiving the last AMD PDU segment with the set poll bit (S1480). The status report may include a sequence number of an AMD PDU to be received next by the receiving apparatus, information on reception states of AMD PDUs that have been received but have not been reported yet, information on reception states of AMD PDU segments that have been received or have not been received, or the like. The status report of the embodiment shown in FIG. 14 includes the sequence number of the AMD PDU to be received next, and the sequence number and the segment number of the missing AMD PDU. As described above, since the reception timer duration is shorter than the retransmission timer duration, the status information report transmission due to expiration of the reception timer at the RLC entity of the receiving apparatus may reduce the retransmission latency of the AMD PDU as compared to the status information report transmission due to expiration of the transmission timer after retransmission of an AMD PDU segment at the RLC entity of the transmitting apparatus. Upon receiving the status report due to the expiration of the reception timer at the RLC entity of the receiving apparatus, the RLC entity of the transmitting apparatus may forcibly stop its retransmission timer (S1485). The RLC entity of the transmitting apparatus may transmit the missing AMD PDU segment identified from the received status report when a new AMD PDU or an AMD PDU having the previous sequence number required to be retransmitted is not present in the transmission buffer (S1490). Since the embodiment shown in FIG. 12 is for the case in which the status report includes the sequence number of the AMD PDU to be received next and the sequence number and the segment number of the missing AMD PDU, the RLC entity of the transmitting apparatus may transmit the missing AMD PDU segment S3 to the RLC entity of the receiving apparatus after setting the poll bit of S3 (i.e., p=1).

The receiving apparatus receiving the AMD PDU segment with the set poll bit may transmit status reporting information (i.e., STATUS PDU) to the transmitting apparatus (S1495). In this case, the status report may be transmitted as including only the sequence number of the AMD PDU to be transmitted. When the status report including only the sequence number of the AMD PDU to be received next is received, the transmitting apparatus may determine that all of the segments of the AMD PDU having the previous sequence number have been normally transmitted to the transmitting apparatus.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A method for transmitting data, performed by a transmitting apparatus in a wireless communication system, the method comprising:
transmitting a last acknowledged mode data (AMD) packet data unit (PDU) segment to a receiving apparatus, and activating a retransmission timer;
identifying whether status report transmitted by the receiving apparatus is received until expiration of the retransmission timer; and
when the status report is not received until the expiration of the retransmission timer, and a new AMD PDU and a retransmission-pending AMD PDU are not present in a data buffer, retransmitting the last AMD PDU segment to the receiving apparatus.

2. The method according to claim 1, further comprising, when the status report is received until the expiration of the retransmission timer, and at least one of a new AMD PDU and a retransmission-pending AMD PDU is present in the data buffer, not transmitting the last AMD PDU to the receiving apparatus.

3. The method according to claim 1, wherein the status report includes at least one of information indicating whether at least one AMD PDU segment has been normally received by the receiving apparatus and information on a sequence number of the at least one AMD PDU segment.

4. The method according to claim 3, wherein the status report further includes a sequence number of an AMD PDU that the receiving apparatus is waiting to receive.

5. The method according to claim 1, wherein the last AMD PDU segment includes a poll bit indicating that the last AMD PDU segment is a last segment among a plurality of AMD PDU segments.

6. The method according to claim 1, wherein the data buffer includes at least one of a transmission buffer in which a new AMD PDU is stored and a retransmission buffer in which an AMD PDU required to be retransmitted is stored.

7. A method for receiving data, performed by a receiving apparatus in a wireless communication system, the method comprising:
receiving at least one acknowledged mode data (AMD) packet data unit (PDU) segment for which a poll bit is not set from a transmitting apparatus, and activating a reception timer;
terminating the reception timer when at least one of AMD PDU segments for which the poll bit is set is received until expiration of the reception timer; and
transmitting status report to the transmitting apparatus when the reception timer expires.

8. The method according to claim 7, further comprising receiving at least one AMD PDU segment from the transmitting apparatus, wherein the transmitting apparatus receives the status report until expiration of a retransmission timer, initializes the retransmission timer, and retransmit the at least one AMD PDU segment based on a status of a data buffer of the transmitting apparatus and the status report.

9. The method according to claim 7, wherein the status report includes at least one of information indicating whether at least one AMD PDU segment has been normally received by the receiving apparatus and information on a sequence number of the at least one AMD PDU segment.

10. The method according to claim 9, wherein the status report further includes a sequence number of an AMD PDU that the receiving apparatus is waiting to receive.

11. The method according to claim 7, wherein the data buffer includes at least one of a transmission buffer in which a new AMD PDU is stored and a retransmission buffer in which an AMD PDU required to be retransmitted is stored.

12. The method according to claim 7, wherein the AMD PDU segment retransmitted by the transmitting apparatus is an AMD PDU segment for which the poll bit is set.

13. A transmitting apparatus in a wireless communication system, the transmission apparatus comprising at least one processor, a memory storing at least one instruction executed by the at least one processor, and a transceiver controlled by the at least one processor, wherein the at least one instruction is configured to:
transmit, by using the transceiver, a last acknowledged mode data (AMD) packet data unit (PDU) segment to a receiving apparatus, and activating a retransmission timer;
identify whether status report transmitted by the receiving apparatus is received until expiration of the retransmission timer; and
when the status report is not received until the expiration of the retransmission timer, and a new AMD PDU and a retransmission-pending AMD PDU are not present in a data buffer, retransmit the last AMD PDU segment to the receiving apparatus.

14. The transmitting apparatus according to claim 13, wherein, when the status report is received until the expiration of the retransmission timer, and at least one of a new AMD PDU and a retransmission-pending AMD PDU is present in the data buffer, the at least one instruction is further configured not to transmit the last AMD PDU to the receiving apparatus.

15. The transmitting apparatus according to claim 13, wherein the status report includes at least one of information indicating whether at least one AMD PDU segment has been normally received by the receiving apparatus and information on a sequence number of the at least one AMD PDU segment.

16. The transmitting apparatus according to claim 15, wherein the status report further includes a sequence number of an AMD PDU that the receiving apparatus is waiting to receive.

17. The transmitting apparatus according to claim 13, wherein the last AMD PDU segment includes a poll bit indicating that the last AMD PDU segment is a last segment among a plurality of AMD PDU segments.

18. The transmitting apparatus according to claim 13, wherein the data buffer includes at least one of a transmission buffer in which a new AMD PDU is stored and a retransmission buffer in which an AMD PDU required to be retransmitted is stored.
